(19) United States
(12) Patent Application Publication
(10) Pub. No.: US 2006/0022578 A1
(43) Pub. Date: Feb. 2, 2006

(54) Electron emission device and method for manufacturing

(76) Inventor: Kyung-Sun Ryu, Suwon-si (KR)

Correspondence Address: CHRISTIE, PARKER & HALE, LLP, PO BOX 7068, PASADENA, CA, 91109-7068, US

(21) Appl. No.: 11/191,361

(22) Filed: Jul. 27, 2005

(30) Foreign Application Priority Data
Jul. 30, 2004 (KR) 10-2004-0060603

(51) Int. Cl. H01J 1/14; H01J 1/05; H01J 9/00; H01J 9/24; H01J 1/62

(52) U.S. Cl. 313/497; 313/311; 313/495; 427/77; 445/50

(57) ABSTRACT

An electron emission device includes a first and a second substrate facing each other, cathode electrodes formed on the first substrate, and electron emission regions connected to the cathode electrodes. Gate electrodes are spaced apart from the cathode electrodes by an interposing insulating layer. Phosphor layers are formed on the second substrate. At least one anode electrode is formed on a surface of the phosphor layers. The electron emission region has a first surface facing the first substrate and a second surface facing the second substrate. The second surface of the electron emission region facing the second substrate is smaller in size than the first surface of the electron emission region facing the first substrate.

### CROSS REFERENCE TO RELATED APPLICATION

This application claims priority to and the benefit of Korean Patent Application No. 10-2004-0060603 filed on Jul. 30, 2004 in the Korean Intellectual Property Office, the entire content of which is incorporated herein by reference.

### BACKGROUND OF THE INVENTION

1. Field of the Invention

The present invention relates to an electron emission device. In particular, the embodiments of the present invention relate to an electron emission device having an improved electron emission structure and a method of manufacturing the electron emission device.

2. Description of Related Art

Generally, the electron emission devices are classified into a first type where a hot cathode is used as an electron emission source and a second type where a cold cathode is used as the electron emission source.

Among the second type of electron emission devices are devices known as field emitter array (FEA) type devices, surface-conduction emission (SCE) type devices, metal-insulator-metal (MIM) type devices and metal-insulator-semiconductor (MIS) type devices.

With the FEA type electron emission devices, electron emission regions are formed with a material emitting electrons under the application of an electric field. Driving electrodes including cathode and gate electrodes are provided for controlling electron emissions from the electron emission regions. When electric fields are formed around the electron emission regions due to the voltage difference between the two electrodes, electrons are emitted from the electron emission regions.

With the FEA type electron emission devices proposed in the past, the electron emission regions were spindt-type regions with a sharp-pointed tip made commonly through depositing or sputtering molybdenum (Mo) in a vacuum. In the making of the spindt-type electron emission regions, a semiconductor fabrication process is used, making the processing steps complicated and making it difficult to enlarge the display area.

It has been recently proposed that the electron emission regions should be formed with a carbonaceous material having a low work function, such as carbon nanotube, graphite and diamond-like carbon, using a thick film forming process like screen printing.

To form the electron emission regions with the carbonaceous material using screen printing, a paste-phased mixture is prepared containing an electron emission material. A sacrificial layer is formed on the entire surface of the substrate structure except for the area to be formed with the electron emission regions. The mixture is screen-printed onto the substrate. The sacrificial layer and the mixture printed on the sacrificial layer are removed. The remaining mixture is dried and fired.

The sacrificial layer is commonly formed using a positive-type photosensitive material and deposited on the entire surface of the substrate structure. The electron emission region formation area of the sacrificial layer is selectively exposed to light and the exposed portions thereof are removed to thereby form openings.

However, when the sacrificial layer is exposed to light, the non-exposed portion thereof is partially exposed to light in the borderline area between the exposed and the non-exposed parts of the sacrificial layer due to the light scattering or interference. Accordingly, as shown in FIG. 4, the opening portion 1a of the sacrificial layer 1 is gradually enlarged in width as it recedes from the first substrate 3.

When the electron emission regions are formed using the sacrificial layer 1, as shown in FIG. 5, each electron emission region 5 is gradually enlarged in width as it recedes from the first substrate 3 so that it has an inverted trapezoidal cross-sectional shape. An electron emission region 5 with such a shape exhibits a deteriorated structural stability and is partially extended toward the gate electrode 7 so that a short may be induced between the gate electrode 7 and the underlying cathode electrode 9.

### SUMMARY

In one exemplary embodiment of the present invention, an electron emission device and a method of manufacturing the electron emission device provide an enhanced structural stability for electron emission regions and prevent the cathode and the gate electrodes from shorting.

In an exemplary embodiment of the present invention, the electron emission device includes a first and a second substrate, cathode electrodes formed on the first substrate, and electron emission regions connected to the cathode electrodes. The electron emission region has a first surface facing the first substrate and a second surface facing the second substrate. The second surface of the electron emission region is smaller in size than the first surface of the electron emission region. Gate electrodes are spaced apart from the cathode electrodes while interposing an insulating layer. Phosphor layers are formed on the second substrate. At least one anode electrode is formed on a surface of the phosphor layers.

The electron emission region may have a side elevation cross-sectional shape of a trapezoid. The electron emission regions are placed on the cathode electrodes and the insulating layer. The gate electrodes are formed over the cathode electrodes with openings exposing the electron emission regions on the first substrate.

The electron emission regions may be formed with a material selected from a group including carbon nanotube, graphite, graphite nanofiber, diamond, diamond-like carbon, C₆₀, and silicon nanowire.

In another exemplary embodiment of the present invention, the electron emission device includes a substrate, driving electrodes formed on the substrate, and an electron emission region formed on the driving electrode with carbon nanotubes. The electron emission region has a first surface placed close to the substrate and a second surface placed far from the substrate. The second surface of the electron emission region that is placed far from the substrate may be smaller in size than the first surface of the electron emission region that is placed close to the substrate.

In a method of manufacturing the electron emission device, cathode electrodes, an insulating layer with openings and gate electrodes with openings are first formed on a substrate. A sacrificial layer is formed on the entire surface of the structure of the substrate with a negative-type photosensitive material. The sacrificial layer is over-exposed to light through an exposure mask by placing the exposure mask over the sacrificial layer. The exposure mask has light interception portions corresponding to the electron emission region formation locations. Openings are formed at the sacrificial layer by removing the non-exposed portions of the sacrificial layer. The openings have a width gradually reduced as the openings recede from the substrate. Electron emission regions are formed corresponding to the shapes of the openings by filling the openings of the sacrificial layer with an electron emission material. The sacrificial layer is then removed. The light interception portion of the exposure mask has a perimeter with the same shape (e.g., matching planar cross sections) as the electron emission region facing the substrate.

To form the electron emission regions, a paste-phased mixture may be prepared by mixing an organic material with an electron emission material. The mixture may be selectively printed onto the openings of the sacrificial layer. The printed mixture may then be dried and fired.

Alternatively, with the formation of the electron emission regions, a paste-phased mixture may be prepared by mixing an organic material with an electron emission material. The mixture may be printed on the entire surface of the structure of the substrate. The mixture in the openings of the sacrificial layer may be hardened by placing an exposure mask below the substrate and exposing the mixture to light through the exposure mask. The non-hardened mixture is removed, followed by drying and firing the hardened mixture.

### BRIEF DESCRIPTION OF THE DRAWINGS

FIG. 1 is a partially exploded perspective view of an electron emission device according to an embodiment of the present invention.

FIG. 2 is a partial cross-sectional view of the electron emission device according to one embodiment of the present invention.

FIG. 3A is a diagram of a first phase in one embodiment of a process of manufacturing an electron emission device.

FIG. 3B is a diagram of a second phase in one embodiment of a process of manufacturing an electron emission device.

FIG. 3C is a diagram of a third phase in one embodiment of a process of manufacturing an electron emission device.

FIG. 3D is a diagram of a fourth phase in one embodiment of a process of manufacturing an electron emission device.

FIG. 3E is a diagram of a fifth phase in one embodiment of a process of manufacturing an electron emission device.

FIG. 3F is a diagram of a sixth phase in one embodiment of a process of manufacturing an electron emission device.

FIG. 3B is a diagram of a seventh phase in one embodiment of a process of manufacturing an electron emission device.

FIG. 4 is a partial cross-sectional view of a sacrificial layer used in manufacturing an electron emission device according to prior art.

FIG. 5 is a partial cross-sectional view of the electron emission device according to prior art.

### DETAILED DESCRIPTION

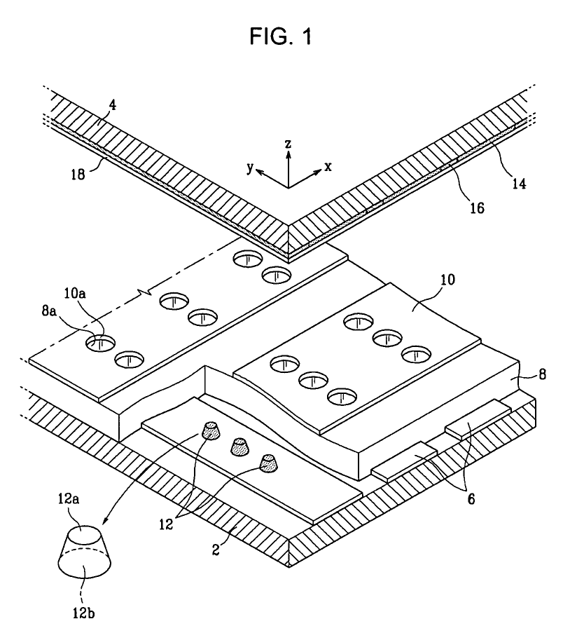

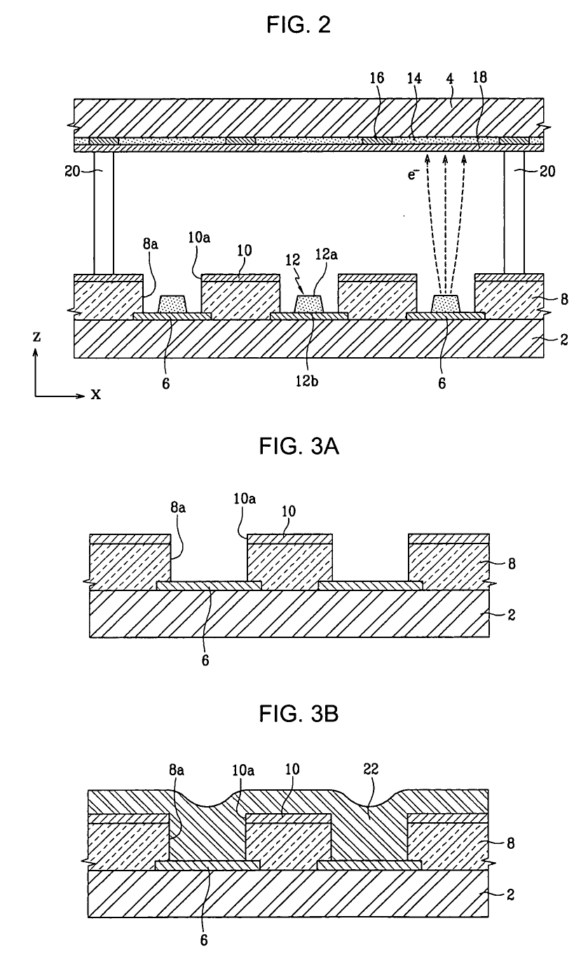

As shown in FIGS. 1 and 2, the electron emission device includes a first substrate 2 and a second substrate 4 facing each other with a predetermined distance between them. An electron emission structure is provided on the first substrate 2 to emit electrons. A light emission structure on the second substrate 4 is provided to emit visible rays generated by the electrons from the electron emission structure, thereby displaying the desired images.

A plurality of cathode electrodes 6 are patterned as stripes on the first substrate 2 laid out in the same direction on the first substrate 2 (in the direction of the y axis of the drawing) while being spaced apart from each other at a set distance. An insulating layer 8 is formed over the entire surface of the first substrate 2 covering the cathode electrodes 6. A plurality of gate electrodes 10 are arranged on the insulating layer 8 with a set distance between them crossing the cathode electrodes 6 (in the direction of the x axis of the drawing).

The crossed regions of the cathode and the gate electrodes 6 and 10 may be referred to as pixel regions. One or more electron emission regions 12 are formed on the cathode electrode 6 in each pixel region. Openings 8a and 10a are formed in the insulating layer 8 and the gate electrodes 10 exposing the electron emission regions 12 in the first substrate 2.

The electron emission regions 12 are formed with a material that emits electrons under the application of an electric field, such as a carbonaceous material or a nanometer-sized material. The electron emission regions 12 may be formed with carbon nanotube, graphite, graphite nanofiber, diamond, diamond-like carbon, C₆₀, silicon nanowire, or a combination thereof.

It is illustrated in the drawings that the electron emission regions 12 have a circular shaped upper and lower surface and are linearly arranged along the length of the cathode electrode 6 in the respective unit pixels. However, the shape of the surfaces, number of electrodes per pixel, and arrangement of the electron emission regions are not limited to that which is illustrated, but may be altered in various manners.

The electron emission region 12 has a first surface 12b facing the first substrate 2 and a second surface 12a facing the second substrate 4. The second surface 12a of the electron emission region 12 is smaller in size than the first surface 12b facing the first substrate 2. That is, the electron emission device 12 is gradually reduced in width as it recedes from the first substrate 2. For example, the electron emission region 12 may have a side elevation cross-sectional shape of a trapezoid.

With the above structure, the electron emission region 12 has a high structural stability. The periphery of the second surface 12a of the electron emission region 12 facing the second substrate 4 is spaced apart from the gate electrode 10 at a suitable distance so that the possible short that may occur between the cathode and the gate electrodes 6 and 10 due to the contact thereof during the formation of the electron emission region 12 can be prevented.

Phosphor layers 14 and black layers 16 are formed on a surface of the second substrate 4 facing the first substrate 2. An anode electrode 18 is formed on the phosphor layers 14 and the black layers 16 with a metallic layer containing aluminum (Al). The anode electrode 18 receives a high voltage from the outside that is required for accelerating the electron beams and reflects the visible rays radiated from the phosphor layers 14 to the first substrate 2 toward the second substrate 4, thereby enhancing the screen luminance.

The anode electrode may be formed with an indium tin oxide (ITO)-based transparent conductive film, instead of the metallic layer. In this embodiment, the anode electrode is formed on a surface of the phosphor layers and the black layers facing the second substrate. The anode electrode may be patterned with a plurality of portions.

Spacers 20 are arranged between the first substrate 2 and the second substrate 4. The first and the second substrates 2 and 4 are sealed to each other at their peripheries using a sealant (not shown), such a glass frit. The space between the first substrate 2 and the second substrates 4 is evacuated to create a vacuum, thereby constructing an electron emission device. The spacers 20 are placed on the non-light emission area where the black layers 16 are located.

In the above-structured electron emission device, when predetermined driving voltages are applied to the cathode electrodes 6 and the gate electrodes 10, electric fields are formed around the electron emission regions 12 due to the voltage difference between the two electrodes so that electrons are emitted from the electron emission regions 12. The emitted electrons are attracted by the high voltage applied to the anode electrode 18 and migrate toward the second substrate 4, thereby colliding against the phosphor layers 14 in the relevant pixels to light-emit them.

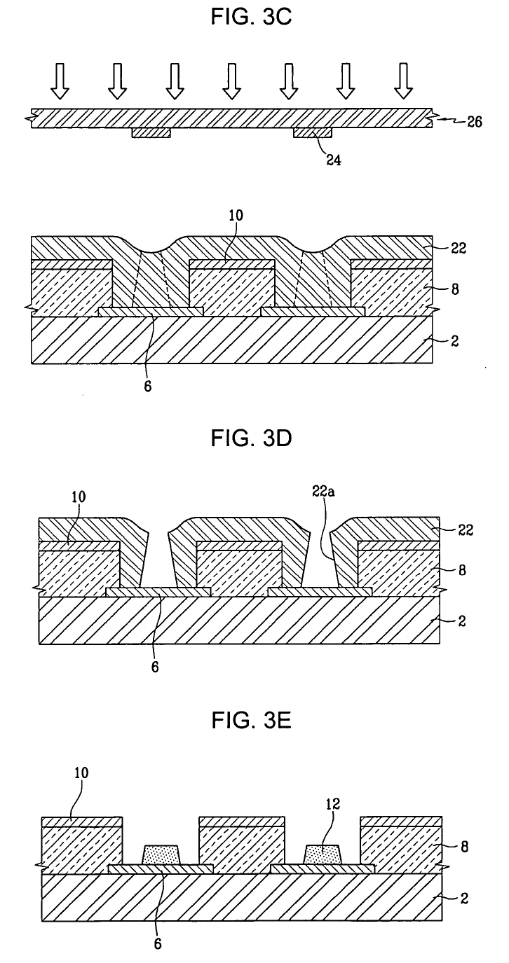

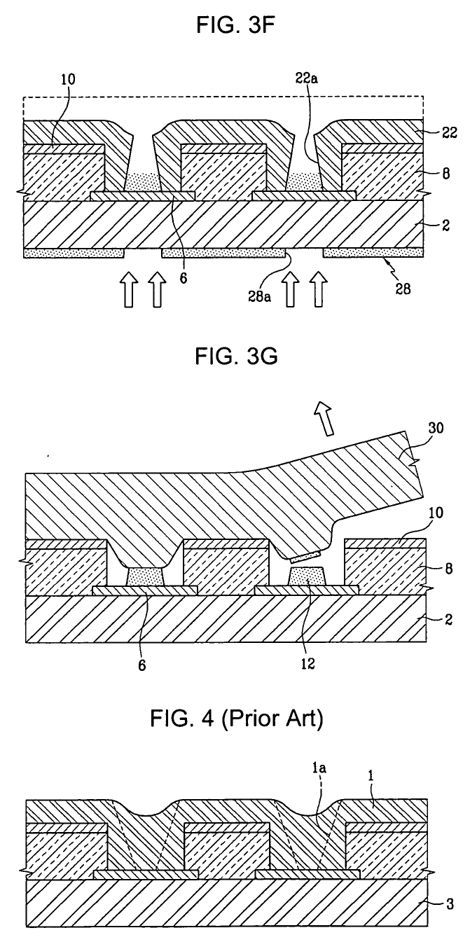

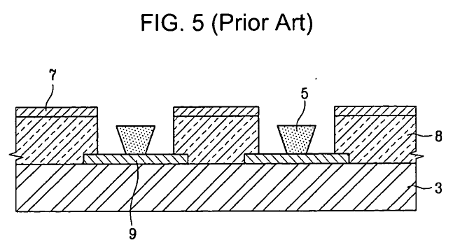

A method of manufacturing the electron emission device according to one embodiment of the present invention will be now explained with reference to FIGS. 3A to 3G. First, as shown in FIG. 3A, cathode electrodes 6 are formed in a stripe pattern on the first substrate 2 and an insulating layer 8 is formed on the entire surface of the first substrate 2 such that it covers the cathode electrodes 6. A conductive material is deposited onto the insulating layer 8, and patterned to thereby form gate electrodes 10 having openings 10a at the regions that cross over the cathode electrodes 6. Screen printing, drying and firing are conducted one or more times to form the insulating layer 8. Depositing or sputtering is conducted to form the gate electrodes 10.

Thereafter, as shown in FIG. 3B, a negative-typed photosensitive material is deposited onto the structure of the first substrate 2 to form a sacrificial layer 22. The light-exposed portion is hardened with the usage of negative type photosensitive material. The openings 8a of the insulating layer 8 are completely filled with the sacrificial layer 22.

As shown in FIG. 3C, an exposure mask 26 with light interception portions is placed over the sacrificial layer 22. The light interception portions 24 are correspondingly arranged over the first substrate 2 at the electron emission region formation locations with the same perimeter shape (e.g., the same planar cross section) as the target electron emission regions. Particularly, in consideration of the over-exposure to be explained next, the light interception portions 24 are preferably formed with the same perimeter shape (e.g., matching planar cross sections) as the first surface 12b of the electron emission region that faces the first substrate, which is the bottom surface of the electron emission region 12 (shown in FIG. 1).

The sacrificial layer 22 is exposed to light through the exposure mask 26 by illuminating the light onto it from above the mask 26. Consequently, the portions of the sacrificial layer 22, except for the portions thereof corresponding to the light interception portions 24, are exposed to light. The light exposure time is established to be longer than the normal light exposure time for the sacrificial layer 22 by 1.5 to 2 times the normal exposure time, such that the sacrificial layer 22 is over-exposed to light.

With the over-exposure, the non-exposed portions of the sacrificial layer 22 corresponding to the light interception portions 24 are partially light-exposed due to the light scattering or interference made at the periphery of the light interception portions 24. The borderline area between the exposed and the non-exposed portions is indicated by the dotted line in the drawing. The non-exposed portions of the sacrificial layer 22 are removed through developing to thereby form openings 22a, as shown in FIG. 3D.

As shown in FIG. 3E, the openings 22a of the sacrificial layer 22 are filled with an electron emission material to thereby form electron emission regions 12, and the remaining sacrificial layer is removed.

To form the electron emission regions 12, an organic material that may be a vehicle and/or binder is mixed with a powdered electron emission material to prepare a mixture with a viscosity suitable for the printing. The mixture is selectively printed onto the openings 22a of the sacrificial layer 22 using a screen mesh (not shown). The printed mixture is then dried and fired.

Alternatively, with the formation of the electron emission regions 12, as shown in FIG. 3F, an organic material in a vehicle or binder and a photosensitive material are mixed with a powdered electron emission material to prepare a mixture with a viscosity suitable for the printing. The mixture is screen-printed onto the topmost portion of the target structure (see the dotted line). An exposure mask 28 is placed at the rear of the first substrate 2 with openings 28a corresponding to the electron emission region formation locations. Light is illuminated to the mixture through the backside of the first substrate 2 to selectively harden the mixture in the openings 22a of the sacrificial layer 22. The non-hardened mixture is removed, followed by drying and firing the hardened mixture.

In the application of the process illustrated in FIG. 3F, the first substrate 2 is formed with a transparent material and the cathode electrodes 6 are formed with an ITO-based transparent conductive film. The resulting electron emission region 12 is gradually reduced in width as it recedes from the first substrate 2 and corresponds to the shape of the opening 22a of the sacrificial layer. That is, the electron emission region 12 has excellent structural stability. The upper periphery of the electron emission region 12 is spaced apart from the gate electrode 10 at a suitable distance so that a short thereof with the gate electrode 10 can be effectively prevented.

As shown in FIG. 3G, an adhesive tape 30 may be attached to the entire surface of the structure of the first substrate 2 and detached from the structure to thereby activate the surface thereof. In the surface activation process, the top surface of the electron emission region 12 is removed, exposing the electron emission material. The electron emission elements are aligned perpendicular to the surface of the first substrate exposing the sharp-pointed ends thereof, thereby increasing the electron emission efficiency.

In the surface activation process, the amount of loss to the electron emission region 12 is minimized due to the high structural stability of the electron emission region 12. The surface activation can be uniformly made with respect to the plurality of electron emission regions 12 arranged on the first substrate 2.

As described above, in the electron emission device according to the embodiments of the present invention, the structural stability of electron emission regions is enhanced and the possible short between the electron emission regions and the gate electrodes is prevented by spacing the upper periphery of the electron emission regions apart from the gate electrodes at a suitable distance. The loss of the electron emission regions during the surface activation process is minimized or reduced and the surface activation is uniformly made, thereby improving the device characteristics.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An electron emission device comprising:
a first substrate and a second substrate facing each other at a predetermined distance;
cathode electrodes formed on the first substrate;
electron emission regions coupled to the cathode electrodes, the electron emission regions each with a first surface facing the first substrate and a second surface facing the second substrate, the second surface being smaller in size than the first surface;
gate electrodes spaced apart from the cathode electrodes by an interposing insulating layer;
phosphor layers formed on the second substrate; and
at least one anode electrode formed on a surface of the phosphor layers.

2. The electron emission device of claim 1, wherein the electron emission regions each have a side elevation cross-sectional shape of a trapezoid.

3. The electron emission device of claim 1, wherein the electron emission regions are placed on the cathode electrodes, and
wherein the insulating layer and the gate electrodes are formed over the cathode electrodes with openings exposing the electron emission regions on the first substrate.

4. The electron emission device of claim 1, wherein the electron emission regions are, formed with a material that is one of a carbon nanotube, a graphite, a graphite nanofiber, a diamond, a diamond-like carbon, C₆₀, and silicon nanowire.

5. An electron emission device comprising:
a substrate;
driving electrodes formed on the substrate; and
an electron emission region formed on the driving electrode,
wherein the electron emission region has a first surface placed close to the substrate and a second surface that is placed far from the substrate, and
wherein the second surface of the electron emission region that is placed far from the substrate is smaller in size than the first surface of the electron emission region placed close to the substrate.

6. The electron emission device of claim 5, wherein the electron emission region has a side elevation cross-sectional shape of a trapezoid.

7. The electron emission device of claim 5, wherein the electron emission region is formed from one of a carbon nanotube, a graphite, a graphite nanofiber, a diamond, a diamond-like carbon, C₆₀, and silicon nanowire.

8. The electron emission device of claim 5, wherein the driving electrodes are cathode electrodes.

9. The electron emission device of claim 5, further comprising:
an insulating layer formed over the substrate; and
a gate electrode patterned over the insulating layer.

10. The electron emission device of claim 9, wherein the gate electrode is spaced apart from the second surface of the electron emission region to prevent a short.

11. An electron emission device comprising:
a substrate;
driving electrodes formed on the substrate; and
an electron emission region formed on the driving electrodes with carbon nanotubes,
wherein the electron emission region has a first surface placed close to the substrate and a second surface that is placed far from the substrate, and
wherein the second surface of the electron emission region that is placed far from the substrate is smaller in size than the first surface of the electron emission region placed close to the substrate.

12. A method of manufacturing an electron emission device, comprising:
(a) forming cathode electrodes, an insulating layer with openings, and gate electrodes with openings on a first substrate;
(b) forming a sacrificial layer on the entire surface of the structure of the first substrate with a negative-type photosensitive material;
(c) over-exposing the sacrificial layer to light through an exposure mask by placing the exposure mask over the sacrificial layer, the exposure mask having light interception portions corresponding to electron emission region formation locations;
(d) forming openings in the sacrificial layer by removing non-exposed portions of the sacrificial layer, the openings having a width that is gradually reduced as the openings recede from the first substrate;
(e) forming electron emission regions corresponding to shapes of the openings by filling the openings of the sacrificial layer with an electron emission material; and
(f) removing the sacrificial layer.

13. The electron emission device of claim 12, wherein the light interception portion of the exposure mask has a perimeter with a same shape as a shape of a perimeter of the electron emission region facing the substrate.

14. The electron emission device of claim 12, wherein forming the electron emission regions comprises:
preparing a paste-phased mixture by mixing an organic material with an electron emission material and selectively printing the mixture onto the openings of the sacrificial layer; and
drying and firing a printed mixture.

15. The electron emission device of claim 12, wherein forming the electron emission regions comprises:
preparing a paste-phased mixture by mixing an organic material with an electron emission material;
printing the mixture on the entire surface of the structure of the substrate;
hardening the mixture in the openings of the sacrificial layer by placing an exposure mask below the substrate;
exposing the mixture to light through the exposure mask;
removing the non-hardened mixture; and
drying and firing the hardened mixture.

16. The method of claim 12, wherein after removing the sacrificial layer is conducted, an adhesive tape is attached to the entire surface of the structure of the first substrate and detached from the structure to remove a surface film from the electron emission regions.

17. The method of claim 12, wherein the electron emission regions are formed with a material that is one of a carbon nanotube, a graphite, a graphite nanofiber, a diamond, a diamond-like carbon, C₆₀, and silicon nanowire.

18. The method of claim 12, further comprising:
forming a second substrate including a phosphor layer, black layer and metallic layer.

19. The method of claim 18, further comprising:
sealing the first substrate to the second substrate using a glass frit.

20. The method of claim 18, further comprising:
evacuating the space between the first substrate and second substrate.
